(19) United States
(12) Patent Application Publication
(10) Pub. No.: US 2020/0166779 A1
(43) Pub. Date: May 28, 2020

(54) PHOTOCHROMIC LENS

(71) Applicant: Chih Ming WU, Tainan (TW)

(72) Inventor: Chih Ming WU, Tainan (TW)

(73) Assignee: KODA OPTICAL CO., LTD., TAINAN (TW)

(21) Appl. No.: 16/198,791

(22) Filed: Nov. 22, 2018

(51) Int. Cl. G02C 7/10

(52) U.S. Cl. CPC G02C 7/102; G02C 2202/16

(57) ABSTRACT

A photochromic lens includes an optical body made of polycarbonates and a polycarbonate film combination located at a front surface of the optical body. The polycarbonate film combination is constructed of a first polycarbonate film and a second polycarbonate film, between which a photochromic material and an optical adhesive are provided. The optical body and the polycarbonate film combination are subsequently placed in a mold into which a molten polycarbonate material is fed. As such, the optical body and the polycarbonate film combination can be joined together after the molten polycarbonate material is cooled and solidified, thus making a lens with a stable and excellent performance on changing color. Preferably, each of the first and second polycarbonate films has a thickness between 0.1 and 0.5 mm. The temperature inside the mold reaches about 260 to 280 degrees C. upon the molten polycarbonate material being fed into the mold.

### BACKGROUND OF THE INVENTION

### Field of the Invention

The present invention relates to a photochromic lens and, more particularly, to a lens that includes a photochromic material layer pre-attached between two polycarbonate films and subsequently placed in a mold to be securely attached on an optical body under a high temperature, thus making a lens having a stable and excellent performance on changing color.

### 2. Description of the Prior Art

For a general lens made of a polycarbonate material being used under a bright sunny day, it is necessary to take some measures to reduce the amount of light allowed to pass through. The most common measure is to apply a color-changing material onto a lens. Conventionally, a layer of color changing material is directly sprayed on one surface of a lens. However, the material directly attached on the lens is easy to fall off, especially when the lens is exposed to the sun or in the rain. There is a need for improvement.

### SUMMARY OF THE INVENTION

One object of the present invention is to provide a photochromic lens, wherein a photochromic martial can be securely attached to an optical body thereof, so that the photochromic material is not easy to fall off, even the lens is exposed to the sun or in the rain.

The photochromic lens comprises an optical body made of polycarbonates and a polycarbonate film combination located at a front surface of the optical body. The polycarbonate film combination is constructed of a first polycarbonate film and a second polycarbonate film, between which a photochromic material and an optical adhesive are provided. Each of the first and second polycarbonate films has a thickness between 0.1 and 0.5 mm. The optical body and the polycarbonate film combination are subsequently placed in a mold into which a molten polycarbonate material is fed. The temperature inside the mold reaches about 260 to 280 degrees C. upon the molten polycarbonate material being fed into the mold. As such, the optical body and the polycarbonate film combination can be joined together after the molten polycarbonate material is cooled and solidified.

According to one aspect of the present invention, the photochromic material is in the form of a layer disposed between the first and second polycarbonate films, and the optical adhesive is provided between the first polycarbonate film and the layer of photochromic material, and between the second poloycarbonate film and the layer of photochromic material. As such, the polycarbonate film combination is formed as a five-layer structure.

The photochromic material, provided in the polycarbonate film combination, reversibly changes color when exposed to ultraviolet light.

One advantageous feature of the photochromic lens is that a photochromic material layer associated therewith is pre-attached between two polycarbonate films to form a polycarbonate film combination, which is subsequently placed on an optical body located in a mold, which is subsequently filled with a molten polycarbonate material, whereby the high temperature of the molten polycarbonate material enables the photochromic material to be securely attached to the optical body. Thus, the photochromic material is not easy to fall off, even though the lens is exposed to the sun or in the rain. This feature renders the lens suitable for various helmets or snow goggle, which requires a lens with a stable performance on changing color to reduce the amount of light allowed to pass through or to enhance contrast.

Other objects, advantages, and novel features of the present invention will become more apparent from the following detailed description when taken in conjunction with the accompanying drawings.

### BRIEF DESCRIPTION OF DRAWINGS

FIG. 1 shows a 3-dimensional view of a photochromic lens according to one embodiment of the present invention.

FIG. 2 shows an exploded view of the photochromic lens.

FIG. 3 shows a 3-dimension view of a photochromic lens, wherein an optical body thereof is provided with adjustment elements.

FIG. 4 shows an exploded view of the photochromic lens provided with the adjustment elements.

FIG. 5 shows a 3-dimensional view of a photochromic lens, which is configured for use in snow goggles.

FIG. 6 shows a 3-dimensional view of a photochromic lens, which is configured for use in another snow goggles.

### DETAILED DESCRIPTION OF THE PREFERRED EMBODIMENTS

To illustrate the features and effect of the present invention, a preferred embodiment with reference to the accompanying drawings is provided in the following.

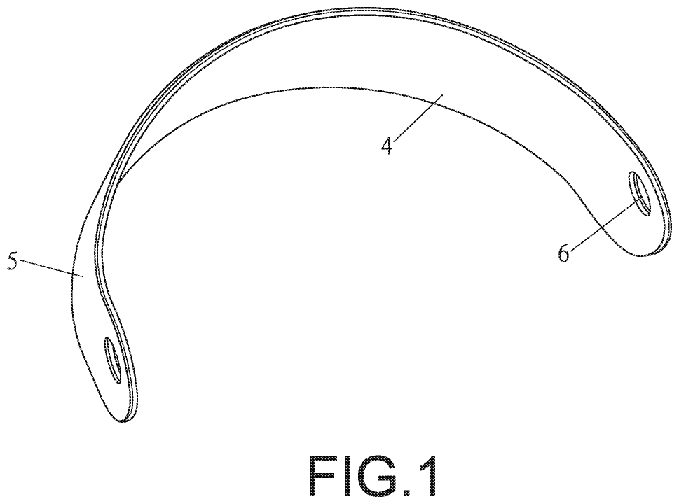

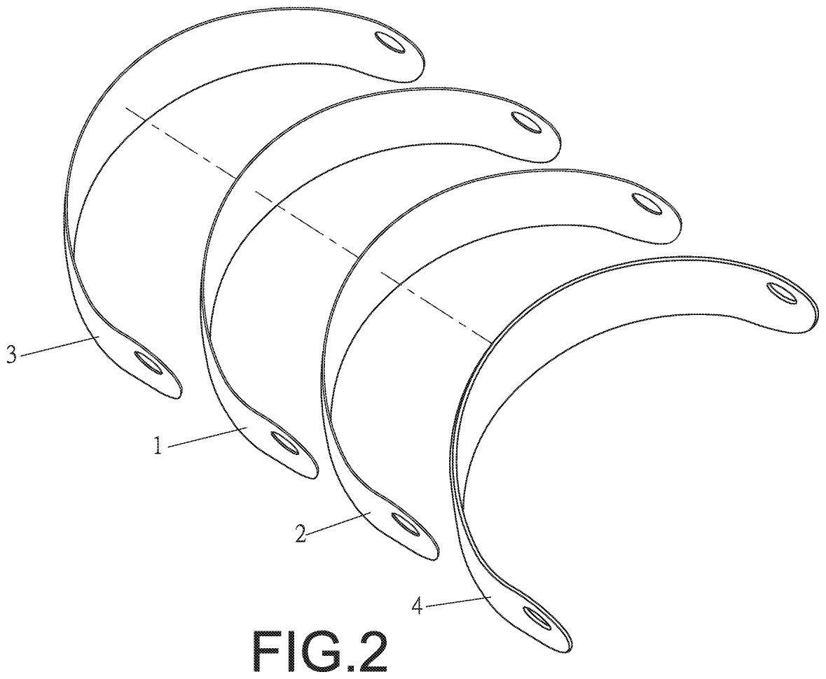

Referring to FIGS. 1 and 2, a photochromic lens according to one embodiment of the present invention is shown, which generally comprises an optical body (transparent body) 4 made of polycarbonates, and a polycarbonate film combination 5 located at a front surface of the optical body 4. The polycarbonate film combination 5 is constructed of a first polycarbonate film 2 and a second polycarbonate film between which a photochromic material 1 and an optical adhesive are provided. More specifically, the photochromic material 1 can be formed into a layer disposed between the first and second polycarbonate films 2, 3, and an optical adhesive can be provided between the first polycarbonate film 2 and the photochromic material layer 1, and between the second polycarbonate film 3 and the photochromic material layer 1. As such, the polycarbonate film combination 5 is formed as a five-layer structure (including a first polycarbonate film, a first adhesive layer, a photochromic material layer, a second adhesive layer, and a second polycarbonate film). Alternatively, a photochromic material can be sprayed on one surface of the first polycarbonate film 2, and an optical adhesive can be provided between the first polycarbonate film 2, which has been added with the photochromic material, and the second polycarbonate film 3.

In use, the photochromic material disposed between the first and second polycarbonate films 2, 3, reversibly changes color when exposure to ultraviolet light. The photochromic material changes back to its original color when removed from ultraviolet light. Preferably, each of the first and second polycarbonate films 2, 3 has a thickness between 0.1 and 0.5 mm.

The photochromic lens of the present invention can be configured to any shapes and applied to various helmets and goggles. As an application example shown in FIGS. 1 and 2, the photochromic lens of the present invention can be employed as a visor of a helmet, wherein the polycarbonate film combination 5 is sized to match with the polycarbonate optical body 4. Also, two mounting holes 6 are defined at two sides of the lens and extend through the optical body 4 and the polycarbonate film combination 5.

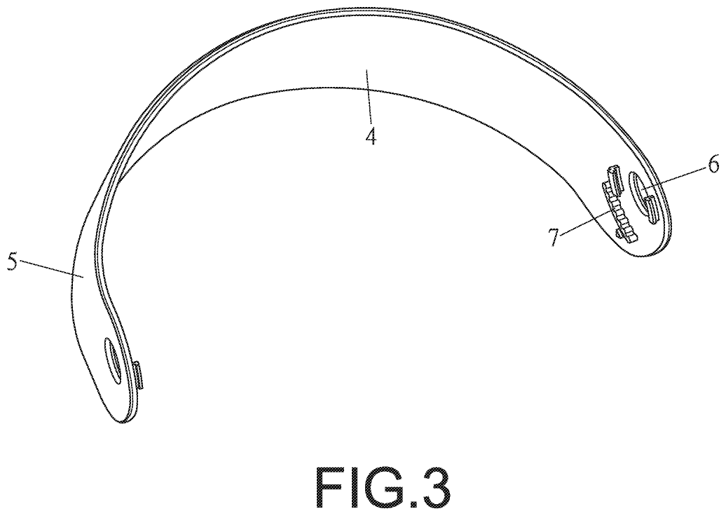

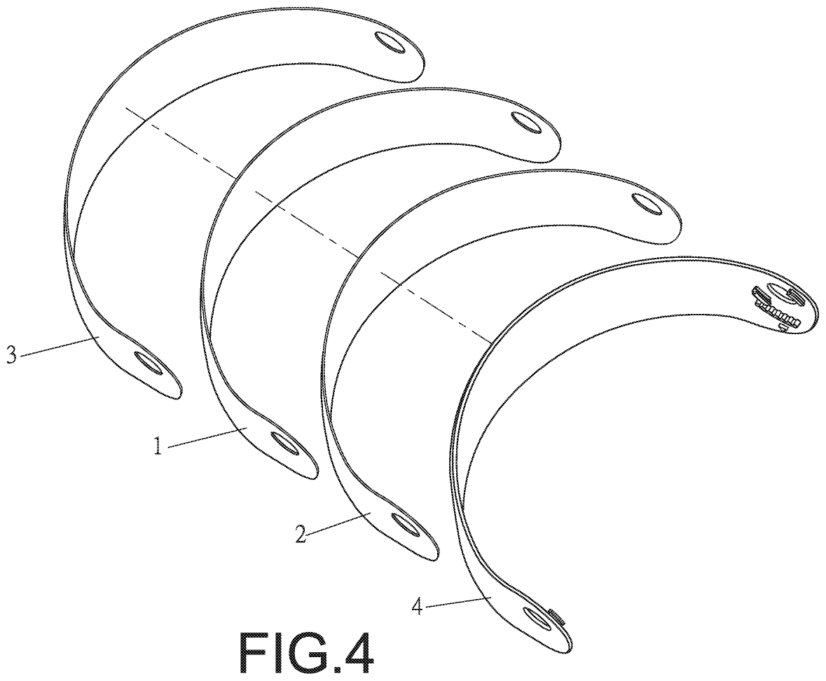

As another application example shown in FIGS. 3 and 4, which are basically same as the one shown in FIGS. 1 and 2, the optical body 4 is provided with two adjustment elements 7 adjacent to the mounting holes 6. The polycarbonate film combination 5 is sized to match with the polycarbonate optical body 4.

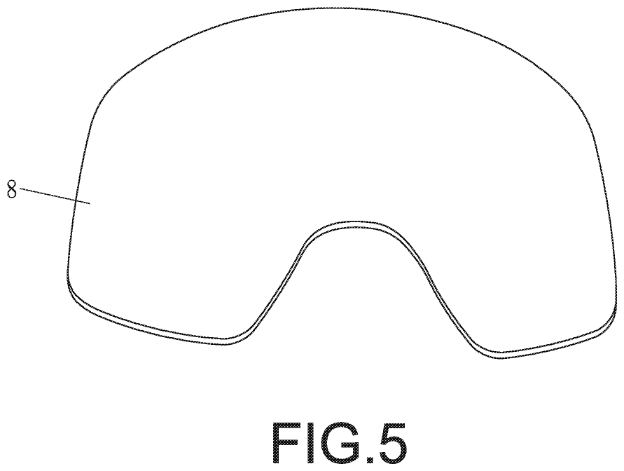

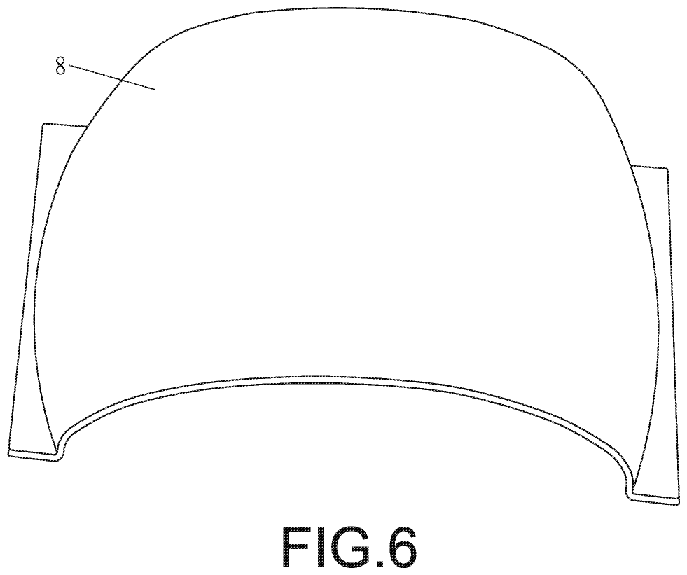

As a further application example shown in FIGS. 5 and 6, the photochromic lens of the present invention is configured as a snow goggle lens.

A method for manufacturing the photochromic lens of the present invention may include the following steps:

Step 1: placing a photochromic material layer 1 between a first polycarbonate film 2 and a second polycarbonate film 3, and spreading an optical adhesive between the first polycarbonate film 2 and the photochromic material layer 1, and the second polycarbonate film 3 and the photochromic material layer 1 to form a polycarbonate film combination 5, which can be bent by heat to be conformed to an optical body 4;

Step 2: placing the polycarbonate film combination 5 in a mold, on a front surface of the optical body 4 that had been located in the mold; and

Step 3: injecting a molten polycarbonate material into the mold such that the interior of the mold achieves a temperature between 260 and 280 degrees C. upon the molten polycarbonate material being fed into the mold, thus forming a multi-layered photochromic lens after the molten polycarbonate material is cooled and solidified.

It is noted that the above temperature range, between 260 and 280 degrees C., is the temperature of the polycarbonate material which has been fully melted and fed by a screw to enter the mold. There is no limitation about the pressure of the molten polycarbonate material and the time of the material retained in the mold, if the two pieces can be secured. Also, it is noted that the polycarbonate films 2, 3 are indispensable in making a photochromic lens. Thus, the polycarbonate films 2, 3 serve as a key element in the present invention. With the two polycarbonate films 2, 3 pre-attached with the photochromic material layer 1 to form a combination, a photochromic lens can be successfully produced in the subsequent molding process.

While the invention has been described with reference to the preferred embodiment above, it should be recognized that the preferred embodiment is given for the purpose of illustration only and is not intended to limit the scope of the present invention and that various modifications and changes, which will be apparent to those skilled in the relevant art, may be made without departing from the scope of the invention.

What is claimed is:

1. A photochromic lens, which comprises an optical body made of polycarbonates and a polycarbonate film combination located at a front surface of the optical body, wherein the polycarbonate film combination is constructed of a first polycarbonate film and a second polycarbonate film, between which a photochromic material and an optical adhesive are provided; the optical body and the polycarbonate film combination are subsequently placed in a mold into which a molten polycarbonate material is fed, whereby the optical body and the polycarbonate film combination are joined together after the molten polycarbonate material is cooled and solidified.

2. The photochromic lens of claim 1, wherein the photochromic material is formed into a layer disposed between the first and second polycarbonate films, and the optical adhesive is provided between the first polycarbonate film and the layer of photochromic material, and between the second poloycarbonate film and the layer of photochromic material.

3. The photochromic lens of claim 2, wherein each of the first and second polycarbonate films has a thickness between 0.1 and 0.5 mm.

4. The photochromic lens of claim 3, wherein the temperature inside the mold reaches about 260 to 280 degrees C. upon the molten polycarbonate material being fed into the mold.
